(19) United States
(12) Patent Application Publication
(10) Pub. No.: US 2026/0120930 A1
(43) Pub. Date: Apr. 30, 2026

(54) H-BRIDGE-BASED SOLENOID

(71) Applicant: Halliburton Energy Services, Inc., Houston, TX (US)

(72) Inventors: Imran Sharif Vehra, Houston, TX (US); Lucian Popescu, Houston, TX (US)

(21) Appl. No.: 18/930,197

(22) Filed: Oct. 29, 2024

(51) Int. Cl. H01F 7/18; G01B 7/02; H01F 7/16

(52) U.S. Cl. CPC H01F 7/1872; H01F 7/16; G01B 7/023; H01F 2007/1888

(57) ABSTRACT

Techniques for operating a solenoid include cycling the solenoid, which comprises an H-bridge circuit with a power source and an inductor, between a first operational configuration and a second operational configuration for a first pattern segment. The techniques further include cycling, in response to completing the first pattern segment, the solenoid between a third operational configuration and a fourth operational configuration for a second pattern segment.

### BACKGROUND

Some techniques employed when drilling well systems (whether for extraction of petroleum products, geothermal energy, or other uses) use strong magnetic fields to take various measurements. For example, a ranging tool placed down in a well may generate a large magnetic field to determine the distance between the well and an adjacent well or a resistivity tool may generate a large magnetic field to determine properties of the surrounding formation. These tools may use solenoids to generate the requisite magnetic field.

### BRIEF DESCRIPTION OF THE DRAWINGS

Embodiments of the disclosure may be better understood by referencing the accompanying drawings.

FIG. 1 depicts a free-wheeling pulse width modulator H-bridge circuit usable as a component in a well system, according to some implementations.

FIG. 2 depicts a chart illustrating the pulsing pattern used to open and close the switches in a free-wheeling pulse width modulator H-bridge circuit, according to some implementations.

FIG. 3 depicts a free-wheeling pulse width modulator H-bridge circuit in an initial configuration, according to some implementations.

FIG. 4 depicts a free-wheeling pulse width modulator H-bridge circuit in a first operational configuration of a first modulation pattern, according to some implementations.

FIG. 5 depicts a free-wheeling pulse width modulator H-bridge circuit in a second operational configuration of a first modulation pattern, according to some implementations.

FIG. 6 depicts a free-wheeling pulse width modulator H-bridge circuit in a third operational configuration of a first modulation pattern, according to some implementations.

FIG. 7 depicts a free-wheeling pulse width modulator H-bridge circuit in a fourth operational configuration of a first modulation pattern, according to some implementations.

FIG. 8 is a state diagram illustrating state transitions for a free-wheeling pulse width modulator H-bridge circuit, according to some implementations.

FIG. 9 depicts a free-wheeling pulse width modulator H-bridge circuit in a first operational configuration of a second modulation pattern, according to some implementations.

FIG. 10 depicts a second free-wheeling pulse width modulator H-bridge circuit in a second operational configuration of a second modulation pattern, according to some implementations.

FIG. 11 depicts a free-wheeling pulse width modulator H-bridge circuit in a third operational configuration of a second modulation pattern, according to some implementations.

FIG. 12 depicts a second free-wheeling pulse width modulator H-bridge circuit in a third operational configuration of a second modulation pattern, according to some implementations.

FIG. 13 depicts a free-wheeling pulse width modulator H-bridge circuit in a first operational configuration of a third modulation pattern, according to some implementations.

FIG. 14 depicts a free-wheeling pulse width modulator H-bridge circuit in a second operational configuration of a third modulation pattern, according to some implementations.

FIG. 15 depicts a free-wheeling pulse width modulator H-bridge circuit in a third operational configuration of a third modulation pattern, according to some implementations.

FIG. 16 depicts a free-wheeling pulse width modulator H-bridge circuit in a fourth operational configuration of a third modulation pattern, according to some implementations.

FIG. 17 depicts a free-wheeling pulse width modulator H-bridge circuit with a digital control system usable as a component in a well system, according to some implementations.

FIG. 18 depicts a first example reference waveform that can be reproduced by a free-wheeling pulse width modulator H-bridge circuit, according to some implementations.

FIG. 19 depicts a second example reference waveform that can be reproduced by a free-wheeling pulse width modulator H-bridge circuit, according to some implementations.

FIG. 20 depicts a third example reference waveform that can be reproduced by a free-wheeling pulse width modulator H-bridge circuit, according to some implementations.

FIG. 21 is a flowchart depicting example operations for controlling a free-wheeling pulse width modulator H-bridge circuit usable as a component in a well system, according to some implementations.

FIG. 22 is a flowchart depicting example operations for adjusting the operational configuration parameters for a free-wheeling pulse width modulator H-bridge circuit usable as a component in a well system, according to some implementations.

FIG. 23 is a diagrammatic illustration of an example well system, according to some implementations.

FIG. 24 is a block diagram depicting an example computing system, according to some implementations.

### DESCRIPTION

The description that follows includes example systems, methods, techniques, and program flows that embody aspects of the disclosure. However, it is understood that this disclosure may be practiced without these specific details. In some instances, well-known instruction instances, protocols, structures, and techniques have not been shown in detail in order not to obfuscate the description.

Well system operations, such as drilling, may use various techniques that employ magnetic fields for measurements. For example, a ranging tool may be lowered into a first well and made to generate a large magnetic field. The magnetic field generated by the ranging tool can be used to determine the distance between the first well and a second well. As another example, wireline applications, where instruments and tools are lowered down into the wellbore after drilling is completed, can benefit for similar reasons.

One mechanism for generating the magnetic field used in well system operations is a solenoid employing an H-bridge circuit (“H-bridge”). An H-bridge utilizes a set of switches (e.g., field-effect transistors) to send an electric current through a transistor in alternating directions. In particular, when a first set of switches are closed and a second set of switches are open, the current flows through the inductor in a first direction; when the first set of switches are open and the second set of switches are closed, the current flows through the inductor in the opposite direction.

Such implementations have complexities and unwanted characteristics. First, direct-current-to-direct-current converters may be needed to limit the current of the input voltage, reducing efficiency and increasing the complexity of the design. Second, the amount of current traveling through the inductor in alternating directions may result in significant amounts of distortion and/or noise. Third, large capacitor banks may be needed to absorb the inductive kick from the inductor as the current through the inductor is changed. Last, the static nature of the switching mechanism limits the available waveforms that can be generated.

However, a solenoid featuring a free-wheeling pulse width modulator H-bridge can reduce the need for a large capacitor bank, reduce inductive kick, reduce distortion and noise, allow for variable waveform generation, and reduce the power requirements on the power source while also producing better load characteristics.

In particular, given a solenoid featuring an H-bridge consisting of a current source, four switches S1, S2, S3, and S4, and an inductor L1, the H-bridge can be cycled through operational configurations using a unique pulsing algorithm. To force the current through the inductor L1 in the positive direction, switch S1 may be closed momentarily (e.g., on the order of a few microseconds, depending upon the switching frequency). During this cycle switch S4 is kept closed and switch S3 is open. As soon as switch S1 is opened, switch S2 is closed. Switch S2 acts as a free-wheeling device as it lets the current in the solenoid circulate on its own. Switch S1 and switch S2 are therefore simply complementary of each other or 180 degrees out of phase, with some dead time in between to avoid shoot-through. The duty cycle of the H-bridge pulse width modulator can be first increased to achieve the rising phase of the sinewave (0 to 90 degrees) and then reduced to achieve the falling phase of the sinewave (90 to 180 degrees). After 180 degrees the functionality of the switches are swapped to obtain the remaining 180 degrees to 360 degrees portion of the waveform.

The advantages of the free-wheeling H-bridge pulse width modulator solenoid include drastic simplification of the system design by eliminating the need for a low voltage direct-current-to-direct-current converter; reduction in size or elimination of the need for a large capacitor bank to absorb the inductive kick; reduced electrical noise and harmonics; high efficiency and high reliability, with the modulator only injecting needed energy to the solenoid cycle-by-cycle, which also reduces the temperature rise in the electronics; providing a wide current capability and range since the solenoid current is regulated through pulse width modulation, firmware, etc., instead of via a pre-regulator; providing a high degree of flexibility in the shape of the current waveform through the solenoid, with the modulator being capable of outputting a wide range of current shapes, frequency, and amplitudes using software control or configurable tooling; reduced system noise since the energy circulating through the system may be limited to only the required amount of energy; and low heat dissipation and improved reliability.

The advantages of the free-wheeling H-bridge pulse width modulator extend to the current source as well. In particular, existing H-bridge-based solenoids result in large spikes in power drawn from the current source when the direction of the current changes. A free-wheeling H-bridge pulse width modulator, on the other hand, incrementally ramps up the power drawn from the current source.

Given the difficulty of getting tools down a wellbore and the more challenging conditions presented deep within a wellbore, improved reliability, reduced temperature rise, are particularly useful traits. Further, reduced complexity can result in smaller tools, which are useful in applications that have significant space constraints like drilling wells.

A digital control system using a feedforward or feedback design can be used to control the H-bridge. In such implementations, a sampling analog-to-digital converter generates a digital signal from the solenoid current and the digital control system compares the digital signal of the solenoid current to a reference waveform. The reference waveform can be embedded in the digital control system, can be written to memory in the digital control system, can be provided as dynamic input to the digital control system, etc. A proportional integral derivative (“PID”) algorithm module can then determine the appropriate duty cycle, feeding said duty cycle into a pattern generator and driver module that can then toggle the switches.

### First Example H-Bridge Circuit Modulation Pattern

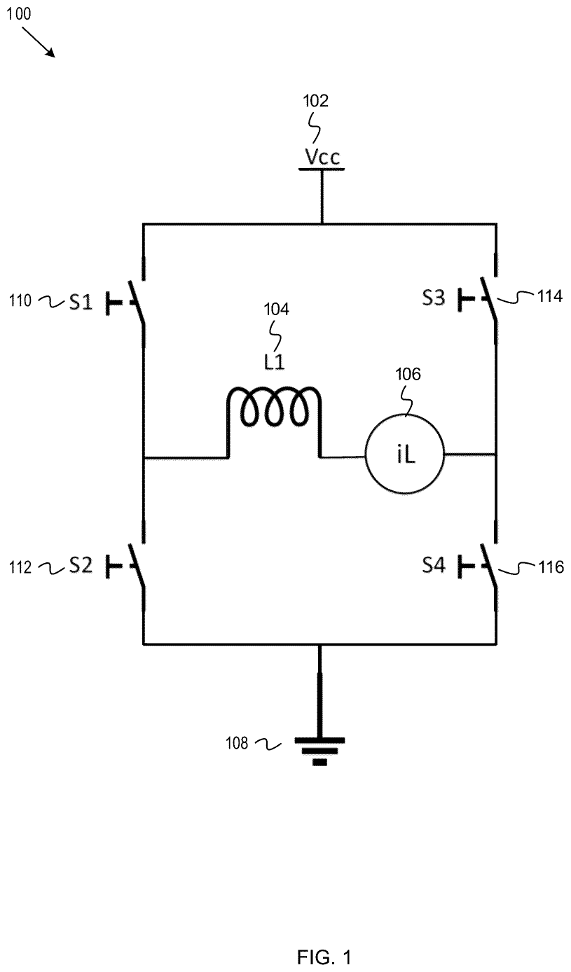

FIG. 1 depicts a free-wheeling pulse width modulator H-bridge circuit usable as a component in a well system, according to some implementations. FIG. 1 depicts an H-bridge circuit 100 (“H-bridge 100”) comprising a power source 102, an inductor 104, a current sensor 106, a ground 108, a first switch 110, a second switch 112, a third switch 114, and a fourth switch 116. The current sensor 106 can be any device that directly measures the current (e.g., an ammeter, current probe, etc.) or indirectly measures the current (e.g., magnetometer measuring the magnetic field generated by the inductor 104).

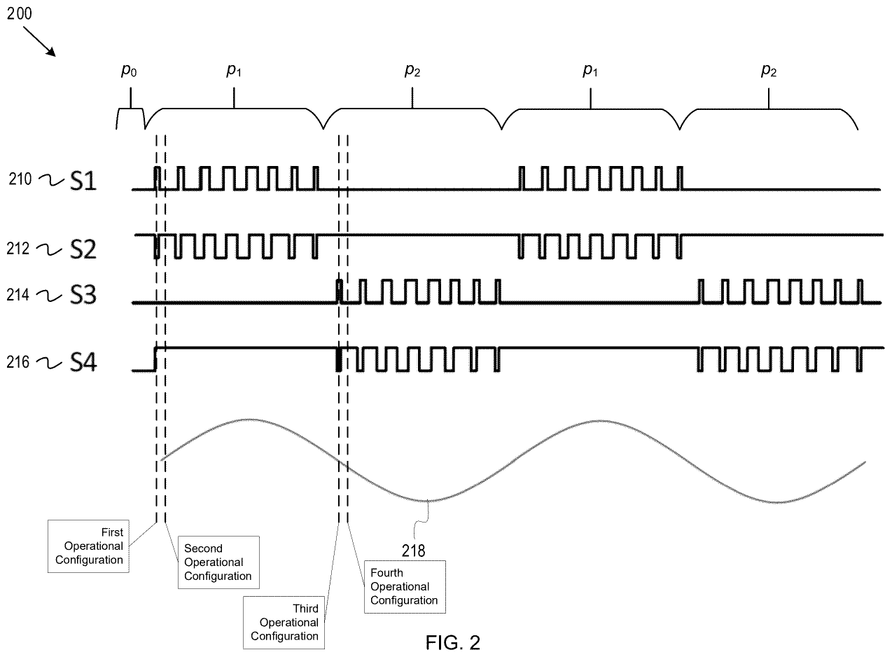

FIG. 2 depicts a chart illustrating the pulsing pattern used to open and close the switches in a free-wheeling pulse width modulator H-bridge circuit, according to some implementations. FIG. 2 depicts a chart 200 with a first pulse width modulation pattern 210 corresponding to the first switch 110, a second pulse width modulation pattern 212 corresponding to the second switch 112, a third pulse width modulation pattern 214 corresponding to the third switch 114, and a fourth pulse width modulation pattern 216 corresponding to the fourth switch 116, and a target waveform 218. Each pulse width modulation pattern is composed of two repeating pattern segments identified by p₁ and p₂.

In this example, the target waveform 218 is a sine wave and each pattern segment p₁ and p₂ corresponds to half of a period of the target waveform 218. When a modulation pattern is in the “up” position, the corresponding switch is closed, allowing current to pass through the switch; when the modulation pattern is in the “down” position, the corresponding switch is open, preventing current from passing through the switch.

In operation, the switches are opened and closed according to the modulation patterns of chart 200. In particular, the H-bridge 100 cycles through four different operational configurations over a full period consisting of the first pattern segment p₁ and the second pattern segment p_{2,} cycling between a first operational configuration and a second operational configuration during pattern segment p₁ and a third operational configuration and a fourth operational configuration during pattern segment p₂. The duration of time that the H-bridge 100 stays in each operational configuration (the duty cycle) can vary in order to generate a desired waveform.

The chart depicts a small number of pulses for illustrative purposes, but in an actual implementation, pulses may occur frequently and very rapidly (e.g., measured using microseconds) and there may be many more pulses in a cycle. As such, while examples discussed herein are simplified for ease of explanation, implementations are not so limited. Further, the actual pattern segments implemented may vary depending on the desired waveform, characteristics of the components used, operational characteristics (e.g., characteristics of the formation, the maximum ranging distance, etc.).

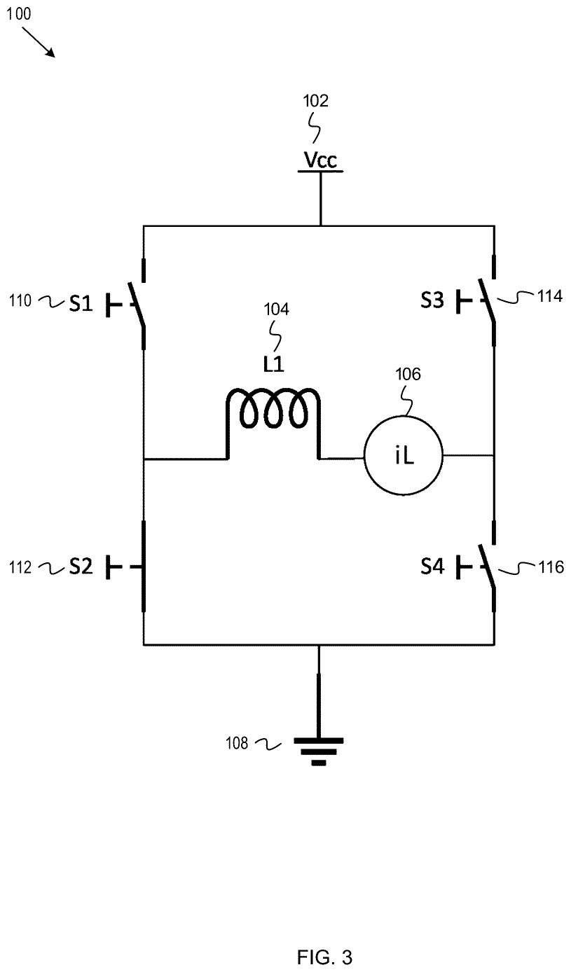

FIG. 3 depicts a free-wheeling pulse width modulator H-bridge circuit in an initial configuration, according to some implementations. FIG. 3 depicts the H-bridge 100 in an initial configuration with the first switch 110, the third switch 114, and the fourth switch 116 open and the second switch 112 closed. In this configuration, no current flows through the system. This configuration corresponds to p₀ in the chart 200.

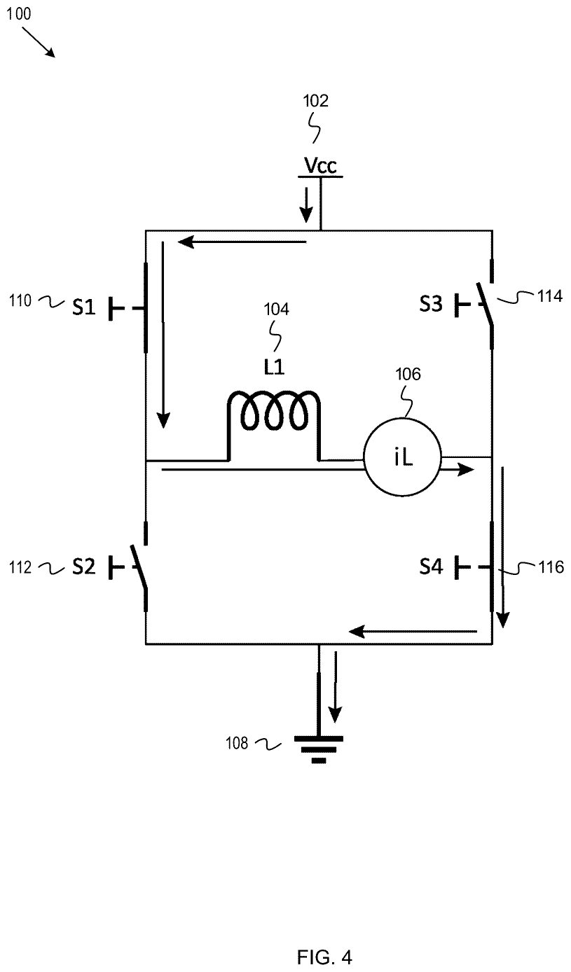

FIG. 4 depicts a free-wheeling pulse width modulator H-bridge circuit in a first operational configuration of a first modulation pattern, according to some implementations. FIG. 4 depicts the H-bridge 100 in a first operational configuration with the first switch 110 and the fourth switch 116 closed and the second switch 112 and the third switch 114 open. In this configuration, current flows from the power source 102 through the first switch 110, then through the inductor 104 in a positive direction, then through the fourth switch 116 to the ground 108, as illustrated by the arrows. This configuration corresponds to the first operational configuration in the chart 200.

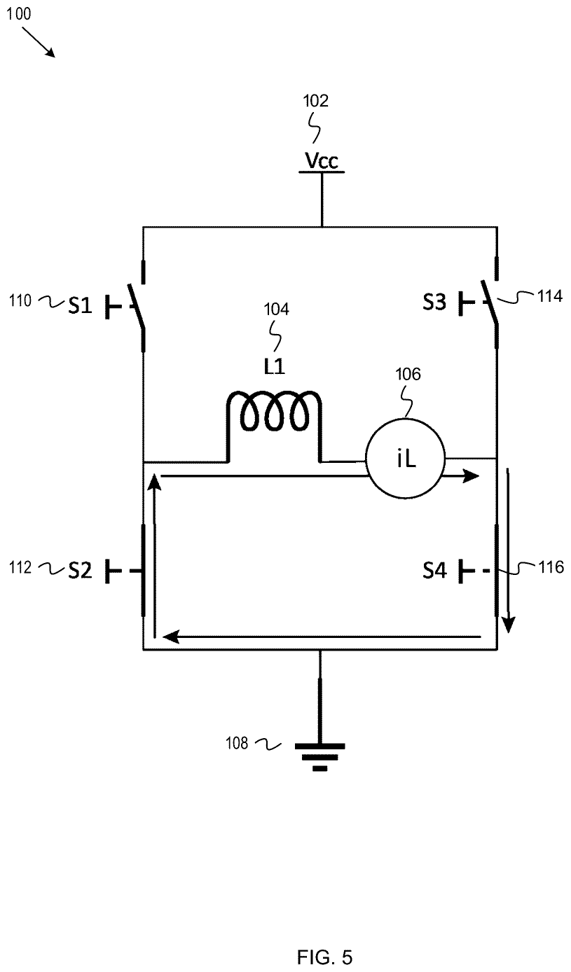

FIG. 5 depicts a free-wheeling pulse width modulator H-bridge circuit in a second operational configuration of a first modulation pattern, according to some implementations. FIG. 5 depicts the H-bridge 100 in a second operational configuration with the second switch 112 and the fourth switch 116 closed and the first switch 110 and the third switch 114 open. In this configuration, current flows in a loop through the inductor 104 in the positive direction, then through the fourth switch 116, the through the second switch 112, and back through the inductor 104 in the positive direction, as illustrated by the arrows. This configuration is a free-wheeling configuration and corresponds to the second operational configuration in the chart 200.

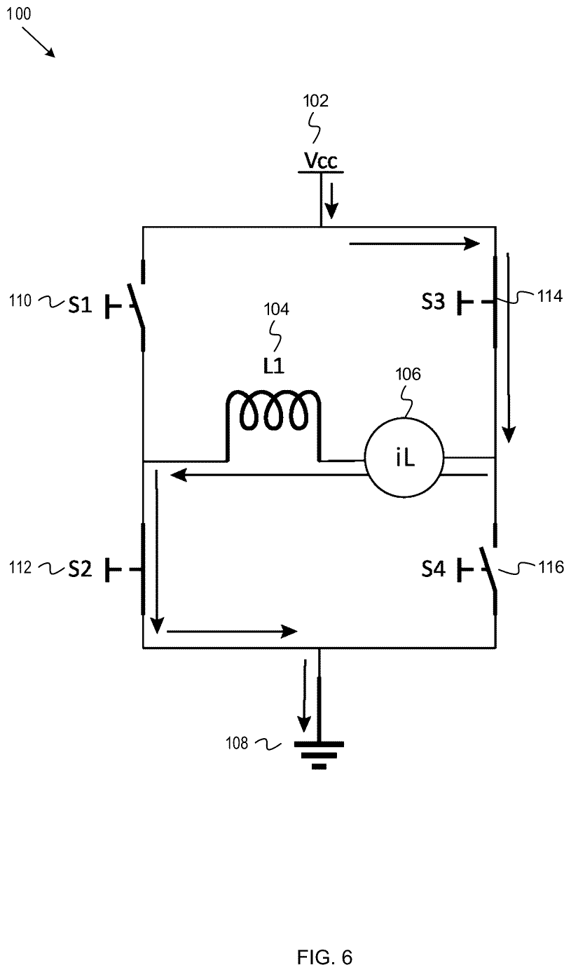

FIG. 6 depicts a free-wheeling pulse width modulator H-bridge circuit in a third operational configuration of a first modulation pattern, according to some implementations. FIG. 6 depicts the H-bridge 100 in a third operational configuration with the second switch 112 and the third switch 114 closed and the first switch 110 and the fourth switch 116 open. In this configuration, current flows from the power source 102 through the third switch 114, then through the inductor 104 in a negative direction, then through the second switch 112 to the ground 108, as illustrated by the arrows. This configuration corresponds to the third operational configuration in the chart 200.

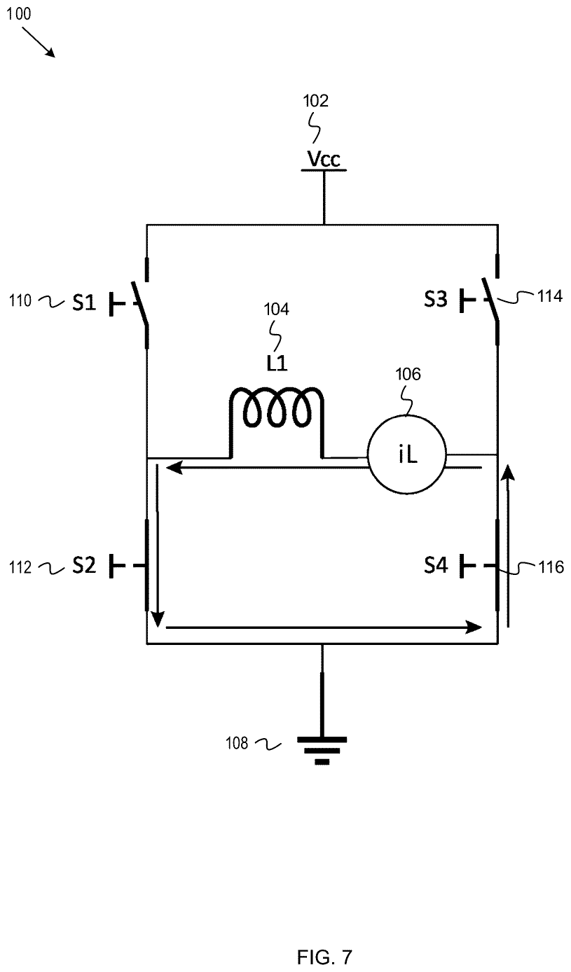

FIG. 7 depicts a free-wheeling pulse width modulator H-bridge circuit in a fourth operational configuration of a first modulation pattern, according to some implementations. FIG. 7 depicts the H-bridge 100 in a fourth operational configuration with the second switch 112 and the fourth switch 116 closed and the first switch 110 and the third switch 114 open. In this configuration, current flows in a loop through the inductor 104 in the negative direction, then through the second switch 112, then through the fourth switch 116, and back through the inductor 104 in the negative direction, as illustrated by the arrows. This configuration is a free-wheeling configuration and corresponds to the fourth operational configuration in the chart 200.

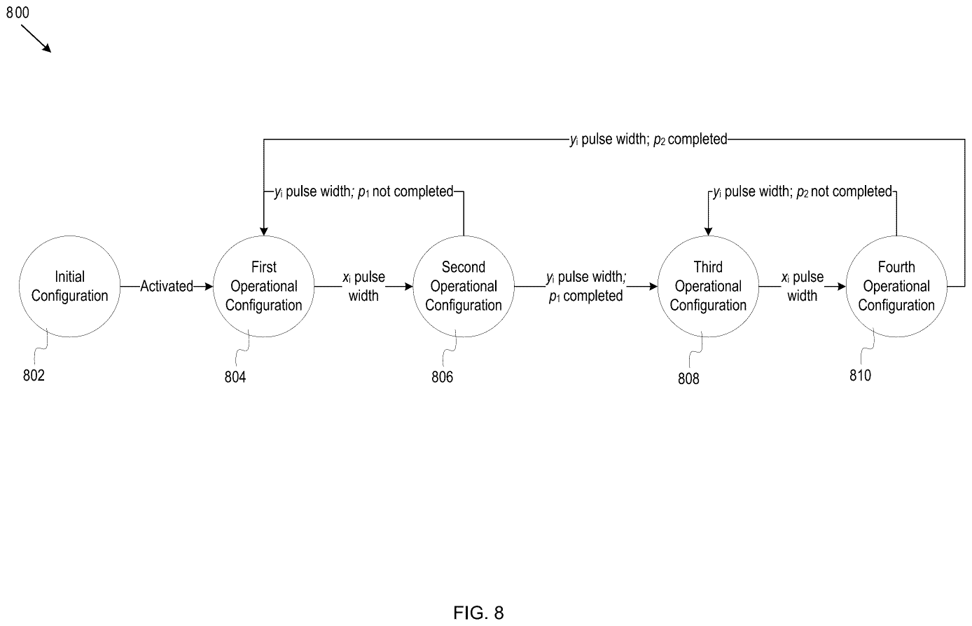

FIG. 8 is a state diagram illustrating state transitions for a free-wheeling pulse width modulator H-bridge circuit, according to some implementations. FIG. 8 depicts a state diagram 800 comprising an initial configuration 802, a first operational configuration 804, a second operational configuration 806, a third operational configuration 808, and a fourth operational configuration 810. The first operational configuration 804 corresponds to the first operation configuration discussed above; the second operational configuration 806 corresponds to the second operation configuration discussed above; the third operational configuration 808 corresponds to the third operational configuration discussed above, and the fourth operational configuration 810 corresponds to the fourth operational configuration discussed above.

As described above, the H-bridge 100 cycles between the first operational configuration 804 and the second operational configuration 806 during pattern segment p₁ and then cycles between the third operational configuration 808 and the fourth operational configuration 810 during pattern segment p₂ before beginning with the first operational configuration 804 and repeating pattern segment p₁ again.

The operation of the H-bridge 100 begins in the initial configuration 802.

When the H-bridge 100 is activated, the H-bridge is put into the first operational configuration 804, beginning pattern segment p₁. The H-bridge 100 remains in the first operational configuration 804 for a pulse width of xᵢ.

After a pulse width of xᵢ has been achieved, the H-bridge 100 is put into the second operational configuration 806. The H-bridge 100 remains in the second operational configuration 806 for a pulse width of yᵢ.

If the pulse width yᵢ has been achieved and pattern segment p₁ has not been completed, the H-bridge 100 is put into the first operational configuration 804.

If pulse width yᵢ has been achieved and pattern segment p₁ has been completed, the H-bridge 100 is put into the third operational configuration 808, beginning pattern segment p₂. The H-bridge 100 remains in the third operational configuration 808 for a pulse width of xᵢ.

After a pulse width of xᵢ has been achieved, the H-bridge 100 is put into the fourth operational configuration 810. The H-bridge 100 remains in the fourth operational configuration 810 for a pulse width of yᵢ.

If a pulse width of yᵢ has been achieved and pattern segment p₂ has not been completed, the H-bridge 100 is put into the third operational configuration 808.

If a pulse width of yᵢ has been achieved and pattern segment p₂ has been completed, the H-bridge 100 is put into the first operational configuration 804, beginning pattern segment p₁ again.

The first operational configuration and the third operational configuration can be viewed as adding current to the H-bridge 100, while the second operational configuration and the fourth operational configuration are free-wheeling configurations where the current in the H-bridge 100 loops through the inductor 104 without current being supplied by the power source 102. Thus, the first operational configuration and the third operational configuration can be viewed as “boosting” the current in the H-bridge 100. When in a free-wheeling configuration, current losses will occur due to inefficiencies in the system, interactions of the magnetic field with the surrounding equipment and formation, etc. Thus, the operational configuration cycling can be viewed as cycling between boosting the amount of current in the H-bridge 100 and draining some of the current in the H-bridge 100.

Pulse width xᵢ represents the amount of time that the H-bridge 100 remains in the first operational configuration or the third operational configuration and pulse width yᵢ represents the length of time that the H-bridge 100 is in the second operational configuration or the fourth operational configuration. If the amount of current added during pulse width xᵢ is greater than the amount of current lost during pulse width yᵢ, the total current in the H-bridge 100 increases; if the amount of current added during pulse width xᵢ is less than the amount of current lost during pulse width yᵢ, the total current in the H-bridge 100 decreases. Thus, by adjusting pulse width xᵢ and pulse width yᵢ, the amount of current in the H-bridge 100 can be incrementally increased (e.g., “ramped up”) and incrementally decreased (e.g., “ramped down”) in a relatively smooth and flexible manner.

For example, the desired target waveform 218 might be created by increasing pulse width xᵢ for the first half of pattern segment p₁ (i.e., the first 90 degrees of the target waveform 218), allowing the current in the H-bridge 100 to ramp up, then decreasing pulse width xᵢ for the second half of pattern segment p₁ (i.e., the second 90 degrees of the target waveform 218), allowing the current in the H-bridge 100 to ramp down. At the end of p₁, the same pattern can be repeated with the current flowing in the opposite direction, thus creating the second 180 degrees of the target waveform 218.

As such, pulse width xᵢ and pulse width yᵢ can be varied to achieve a broad range of desired waveforms. Further, while pulse width xᵢ and pulse width yᵢ are used for both pattern segment p₁ and pattern segment p₂ in this example, the pulse widths used for pattern segment p₁ and pattern segment p₂ need not be the same.

As noted above, the modulation patterns can vary between implementations and may be tailored to the amount of current drain (e.g., from magnetic field absorption) expected from a particular formation. However, the amount of current drain may be unreliable and hard to predict. As such, some implementations of free-wheeling pulse width modulator H-bridge circuits may utilize internal sources of current drain to draw down the circuit in the solenoid.

### Second Example H-Bridge Circuit Modulation Pattern

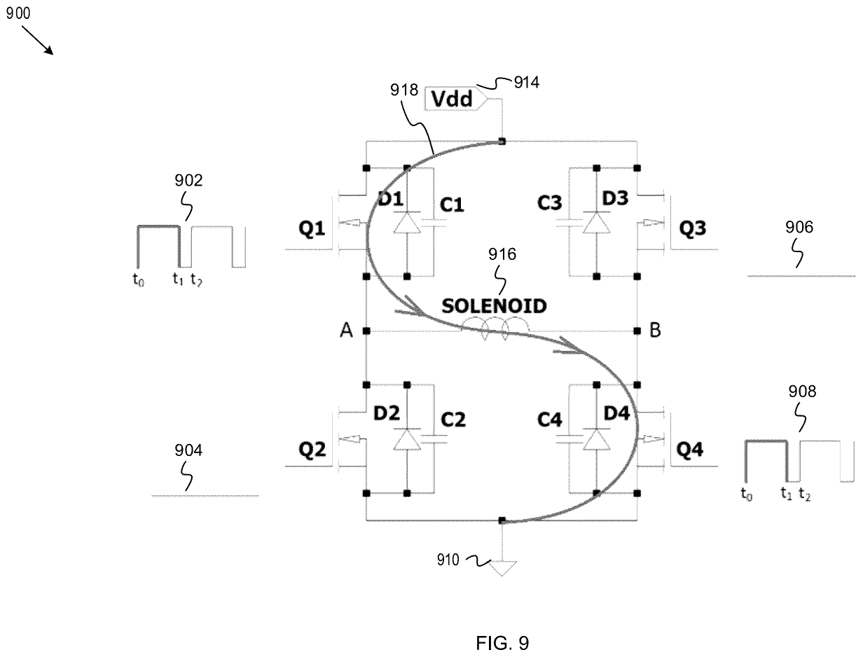

FIG. 9 depicts a free-wheeling pulse width modulator H-bridge circuit in a first operational configuration of a second modulation pattern, according to some implementations. FIG. 9 depicts an H-bridge circuit 900 (“H-bridge 900”) comprising a set of switches Q1, Q2, Q3, and Q4, a set of diodes D1, D2, D3, and D4, a set of capacitors C1, C2, C3, and C4, a power source 914, a ground 910, a inductor 916, a first switching node A, and a second switching node B. FIG. 9 also depicts a first switch modulation pattern 902 for switch Q1, a first switch modulation pattern 904 for switch Q2, a first switch modulation pattern 906 for switch Q3, and a first switch modulation pattern 908 for switch Q4.

The switches Q1, Q2, Q3, and Q4 are represented as MOSFET-type transistors but can be any type of electronic switch, including any type of transistor, solid-state or mechanical relays, etc. Additionally, the set of diodes D1, D2, D3 and D4 could be independent diodes or could be the representation of internal body-diodes associated with MOSFET transistors, if such transistors are used. The capacitors C1, C2, C3 and C4 are depicted in parallel with diodes D1, D2, D3 and D4, respectively. Similarly, these could be independent capacitors or could be the representation of the switches Q1, Q2, Q3 and Q4 parasitic capacitors. Thus, the H-bridge 900 may be the same as, or similar to, the H-bridge 100.

As described herein, by driving the set of switches Q1, Q2, Q3, and Q4 with fixed, high frequency square-wave signals and by modifying the duty-cycle of these driving signals (therefore controlling the ON-time and OFF-time of the switches), the current flowing through the inductor 916 can be forced to take a variety of desired shapes (at various repetition rates and amplitudes). In this example, the modulation patterns illustrate the generation of a 1 Hz sinusoidal alternating current flowing through the inductor 916. However, as noted herein, the modulation pattern can be varied to change the shape of the waveform.

FIG. 9 further depicts the H-bridge circuit 900 in a first operational configuration corresponding to the time period between t₀ and t₁. At time t₀, the current through the inductor 916 is 0 A. From t₀ to t₁, switch Q1 and switch Q4 are switched ON, while switch Q2 and switch Q3 are OFF. During this time, the voltage across the inductor 916 is +Vdd and the current flows through switch Q1 and switch Q4 (as depicted by path 918), ramping up.

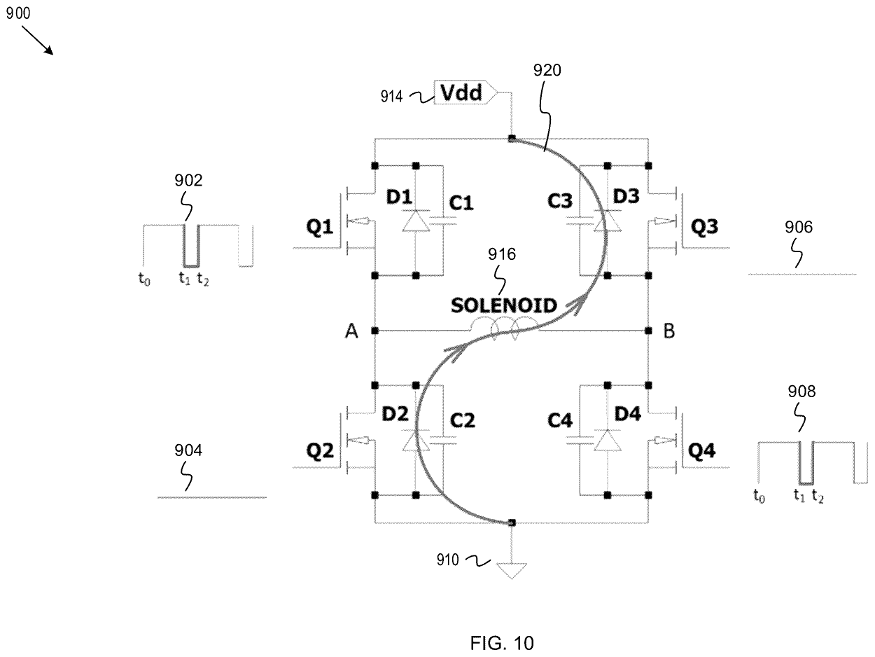

FIG. 10 depicts a second free-wheeling pulse width modulator H-bridge circuit in a second operational configuration of a second modulation pattern, according to some implementations. FIG. 10 depicts the H-bridge 900 in a second operational configuration corresponding to the time period between t₁ and t₂ of first switch modulation pattern 902, first switch modulation pattern 904, first switch modulation pattern 906, and first switch modulation pattern 908.

From t₁ to t₂, switch Q1 and switch Q4 are switched OFF, while switch Q2 and switch Q3 continue to be OFF. Therefore, current continues to flow in the same direction through the inductor 916 (as depicted by path 920), charging capacitor C1 and capacitor C4 and discharging capacitor C2 and capacitor C3 very quickly since the energy stored in the inductor 916 is significantly larger than the energy needed to charge/discharge the capacitors. Hence, switching node A voltage potential reaches and is clamped to ground level by diode D2, while switching node B voltage potential reaches and is clamped to Vdd by diode D3. During this time, the voltage across the solenoid becomes −Vdd and the current starts flowing through the diode D2 and diode D3, ramping down. This high frequency switching process repeats for 250 ms, until the current through the inductor 916 gets to its peak amplitude, taking the sinusoidal shape corresponding to the first ninety degrees of a sine wave. This is possible by making sure that the duty cycle is greater than 0.5 and by being specifically modulated via a digital control algorithm.

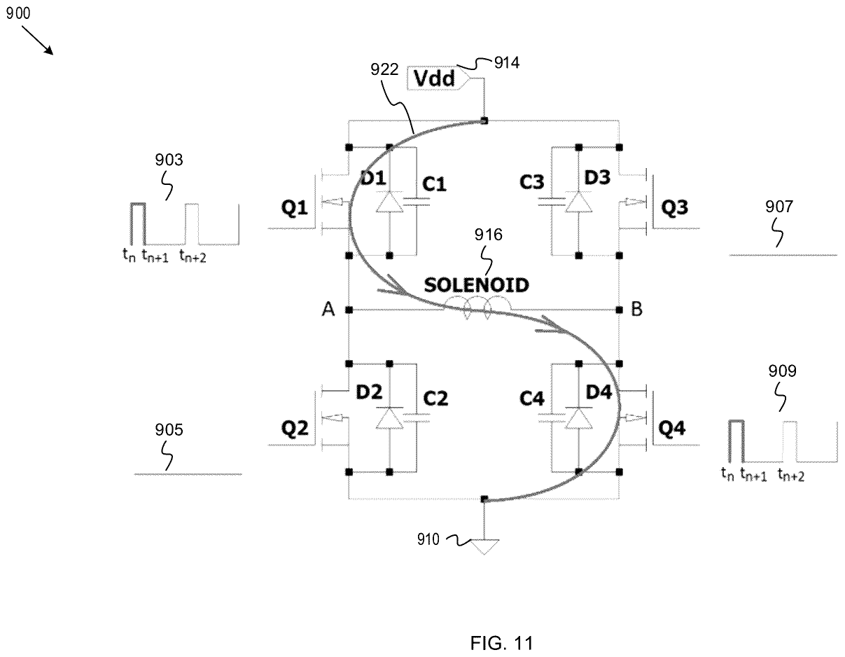

FIG. 11 depicts a free-wheeling pulse width modulator H-bridge circuit in a third operational configuration of a second modulation pattern, according to some implementations. FIG. 11 depicts the H-bridge 900 in a second operational configuration corresponding to the time period between tₙ to tₙ₊₁. FIG. 11 also depicts a second switch modulation pattern 903 for switch Q1, a second switch modulation pattern 905 for switch Q2, a second switch modulation pattern 907 for switch Q3, and a second switch modulation pattern 909 for switch Q4.

At time tₙ, the current through the inductor 916 is at its peak amplitude. From tₙ to tₙ₊₁, switch Q1 and switch Q4 are switched ON, while switch Q2 and switch Q3 are OFF. During this time, the voltage across the solenoid is +Vdd and the current flows through switch Q1 and switch Q4 (as depicted by path 922), ramping up.

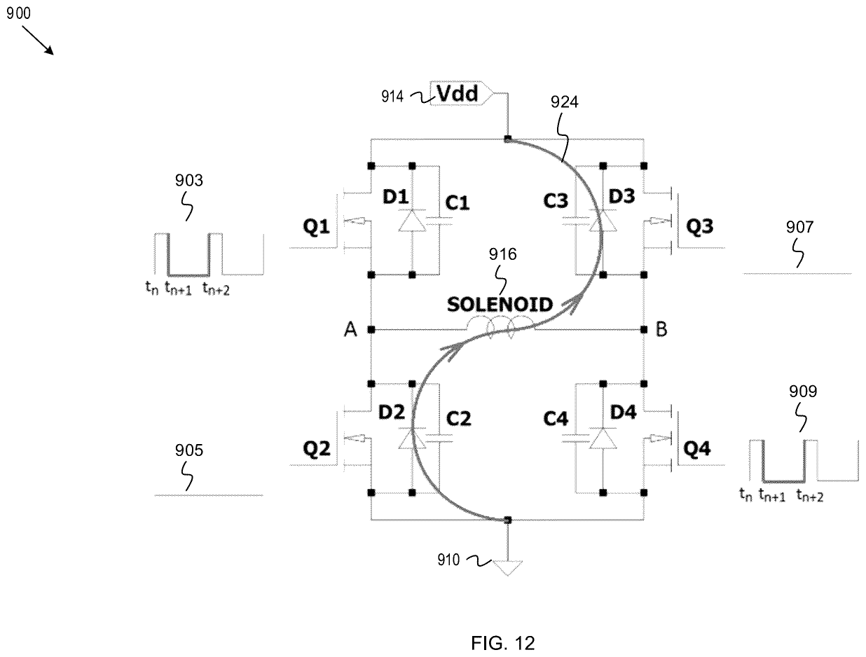

FIG. 12 depicts a second free-wheeling pulse width modulator H-bridge circuit in a third operational configuration of a second modulation pattern, according to some implementations. FIG. 12 depicts the H-bridge 900 in a second operational configuration corresponding to the time period between tₙ₊₁ to tₙ₊₂ of second switch modulation pattern 903, second switch modulation pattern 905, second switch modulation pattern 907, and second switch modulation pattern 909.

From tₙ₊₁ to tₙ₊₂, switch Q1 and switch Q4 are switched OFF, while switch Q2 and switch Q3 continue to be OFF. Therefore, current continues to flow in the same direction through the inductor 916 (as depicted by path 924), charging capacitor C1 and capacitor C4 and discharging capacitor C2 and capacitor C3 very quickly since the energy stored in the inductor 916 is significantly larger than the energy needed to charge/discharge the capacitors. Hence, switching node A voltage potential reaches and is clamped to ground level by diode D2, while switching node B voltage potential reaches and is clamped to Vdd by diode D3. During this time, the voltage across the solenoid becomes −Vdd and the current starts flowing through diode D2 and diode D3, ramping down. This high frequency switching process repeats for the next 250 ms, until the current through the solenoid decreases to zero, corresponding to the second ninety degrees of a sine wave. This is possible by making sure that the duty cycle is less than 0.5 and by being specifically modulated via a digital control algorithm.

For the next 500 ms, the high frequency switching process repeats but with switch Q2 and switch Q3 switching ON and OFF, while switch Q1 and switch Q4 are continuously OFF. Therefore, the current through the inductor 916 reverses direction until completing the full 1 Hz sinusoid period.

### Third Example H-Bridge Circuit Modulation Pattern

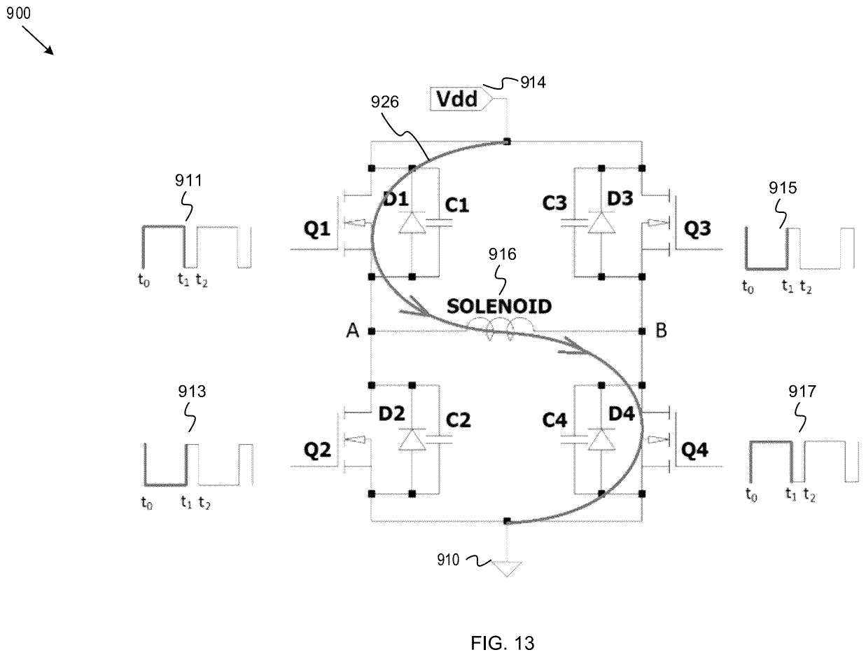

FIG. 13 depicts a free-wheeling pulse width modulator H-bridge circuit in a first operational configuration of a third modulation pattern, according to some implementations. FIG. 13 depicts the H-bridge 900 in a first operational configuration corresponding to the time period between t₀ and t₁. FIG. 13 also depicts a first switch modulation pattern 911 for switch Q1, a first switch modulation pattern 913 for switch Q2, a first switch modulation pattern 915 for switch Q3, and a first switch modulation pattern 917 for switch Q4.

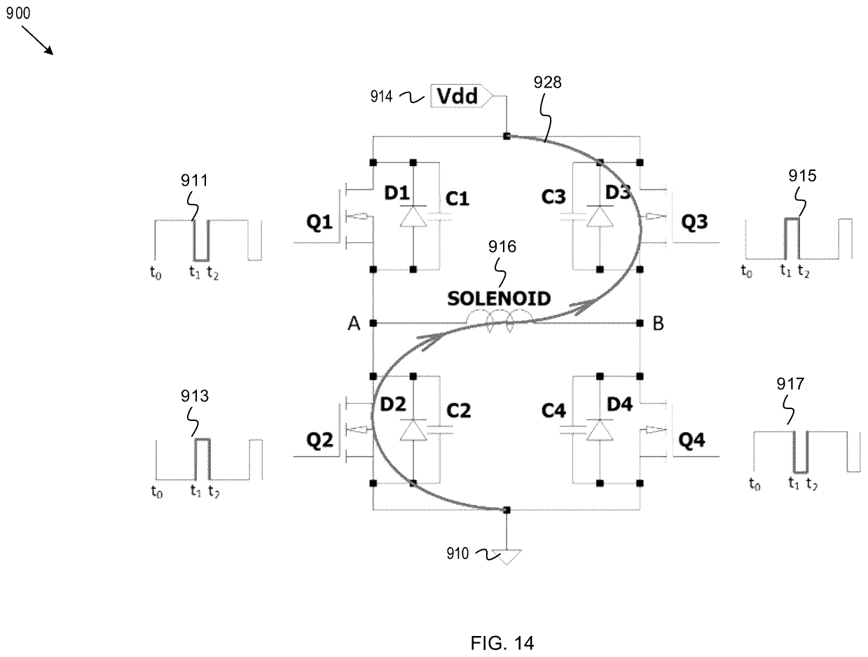

At time to, the current through the inductor 916 is 0 A. From t₀ to t₁, switch Q1 and switch Q4 are switched ON, while switch Q2 and switch Q3 are OFF. During this time, the voltage across the inductor 916 is +Vdd and the current flows through switch Q1 and switch Q4 (as depicted by path 926), ramping up. At time t₁, switch Q1 and switch Q4 are switched OFF, while switch Q2 and switch Q3 continue to be OFF. This will cause capacitor C1 and capacitor C4 to charge and capacitor C2 and capacitor C3 to discharge very quickly since the energy stored in the inductor 916 is significantly larger than the energy needed to charge/discharge the capacitors. Hence, switching node A voltage potential reaches and is clamped to ground level by diode D2, while switching node B reaches and is clamped to Vdd by diode D3. Shortly after this, Q2 and Q3 are switched ON until reaching time t₂, as depicted in FIG. 14, below.

FIG. 14 depicts a free-wheeling pulse width modulator H-bridge circuit in a second operational configuration of a third modulation pattern, according to some implementations. FIG. 14 depicts the H-bridge 900 in a second operational configuration corresponding to the time between when switching node A voltage potential reaches and is clamped to ground level by diode D2 and t₂ of first switch modulation pattern 911, first switch modulation pattern 913, first switch modulation pattern 915 for switch Q3, and first switch modulation pattern 917 for switch Q4.

This modulation pattern improvement (called quasi-resonant, soft-switching sequence) allows for additional power savings, since switch Q2 and switch Q3 switching is timed to be done at 0V across (lossless switching) and current through diode D2 and diode D3 diodes is diverted by switch Q2 and switch Q3 (as depicted by path 928), further reducing conduction losses. During this time, the voltage across the inductor 916 becomes −Vdd and the current flowing through switch Q2 and switch Q3 is ramping down. This high frequency switching process repeats for 250 ms, until the current through the inductor 916 reaches its peak amplitude, taking the sinusoidal shape corresponding to the first 90 degrees of a sine wave. This is possible by making sure that the duty cycle is greater than 0.5 and by being specifically modulated via a digital control algorithm.

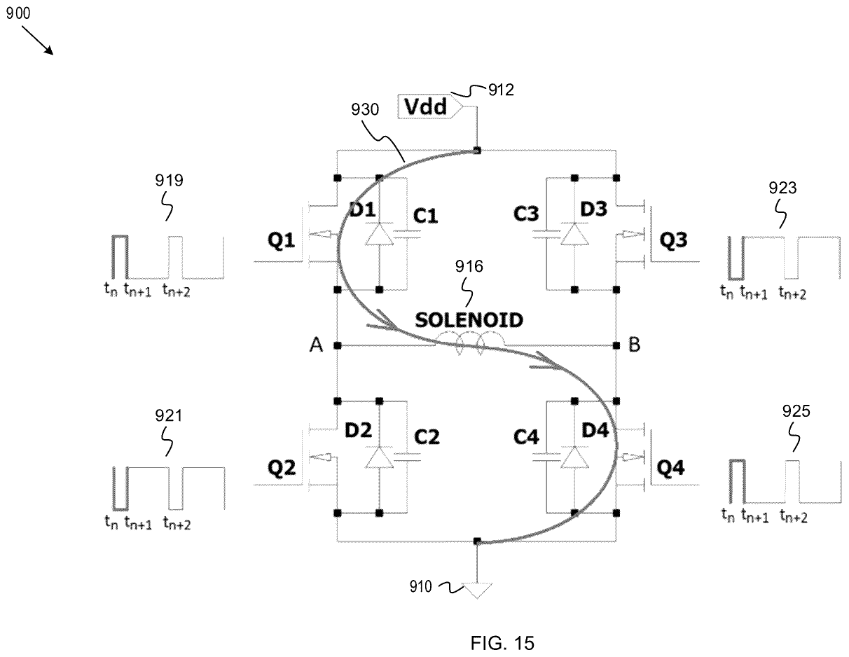

FIG. 15 depicts a free-wheeling pulse width modulator H-bridge circuit in a third operational configuration of a third modulation pattern, according to some implementations. FIG. 15 depicts the H-bridge 900 in a third operational configuration corresponding to the time between tₙ to tₙ₊₁. FIG. 15 also depicts a second modulation pattern 919 for switch Q1, a second modulation pattern 921 for switch Q2, a second modulation pattern 923 for switch Q3, and a second modulation pattern 925 for switch Q4.

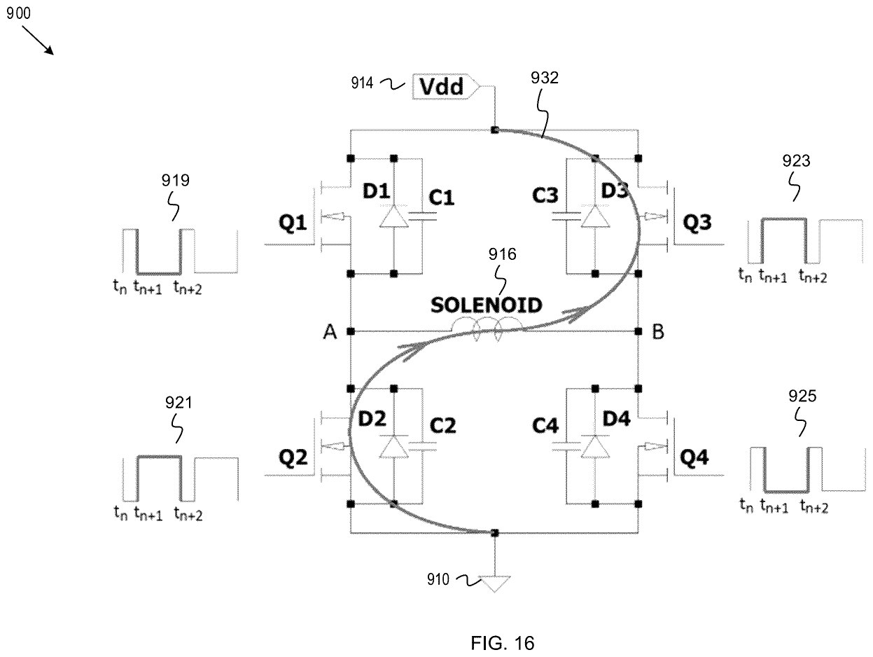

At time tₙ, the inductor 916 is at its peak amplitude. From tₙ to tₙ₊₁, switch Q1 and switch Q4 are switched ON, while switch Q2 and switch Q3 are OFF. During this time, the voltage across the inductor 916 is +Vdd and the current flows through switch Q1 and switch Q4 (as depicted by path 930), ramping up. At time tₙ₊₁, switch Q1 and switch Q4 are switched OFF, while switch Q2 and switch Q3 continue to be OFF. This will cause capacitor C1 and capacitor C4 to charge and capacitor C2 and capacitor C3 to discharge very quickly since the energy stored in the inductor 916 is significantly larger than the energy needed to charge/discharge the capacitors. Hence, the switching node A voltage potential reaches and is clamped to ground level by diode D2, while switching node B reaches and is clamped to Vdd by diode D3. Shortly after this, switch Q2 and switch Q3 are switched ON until time tₙ₊₂, as depicted in FIG. 16, below.

FIG. 16 depicts a free-wheeling pulse width modulator H-bridge circuit in a fourth operational configuration of a third modulation pattern, according to some implementations. FIG. 16 depicts the H-bridge 900 in a fourth operational configuration corresponding to the time between when switching node A voltage potential reaches and is clamped to ground level by diode D2 and time tₙ₊₂ of second modulation pattern 919, second modulation pattern 921, second modulation pattern 923, and second modulation pattern 925.

This modulation pattern improvement (called quasi-resonant, soft-switching sequence) will allow for additional power savings, since switch Q2 and switch Q3 switching is timed to be done at 0V across (lossless switching) and current through diode D2 and diode D3 is diverted by switch Q2 and switch Q3 (as depicted by path 932), further reducing conduction losses. During this time, the voltage across the inductor 916 becomes −Vdd and the current flowing through switch Q2 and switch Q3 is ramping down (as depicted by path 932). This high frequency switching process repeats for 250 ms, until the current through the inductor 816 decreases to zero, taking the sinusoidal shape corresponding to the second ninety degrees of a sine wave. This is possible by making sure the duty cycle is less than 0.5 and by being specifically modulated via a digital control algorithm.

For the next 500 ms, the high frequency switching process repeats, except switch Q2 and switch Q3 are initiating the ON/OFF switching process, while switch Q1 and switch Q4 are followers, in the quasi-resonant, soft switching process explained above. Therefore, the current through the inductor 816 reverses direction, following a sinusoidal shape corresponding to the third and fourth ninety degrees of a sine wave, until completing the full 1 Hz sinusoid period.

### Example Digital Control System

A digital control system can be used to control a free-wheeling pulse width modulator H-bridge circuit (e.g., H-bridge 100). Such a system can be used to vary the length of time that the H-bridge circuit spends in particular operational configurations (e.g., pulse width xᵢ and pulse width yi) as well as the length of time that the H-bridge circuit spends cycling between operational configurations (e.g., pattern segment p₁ and pattern segment p₂), allowing the digital control system to control the wave amplitude, frequency, and shape. Further, a digital control system can include writable memory, allowing operators to dynamically change the characteristics of the H-bridge circuit operations (e.g., the desired waveform).

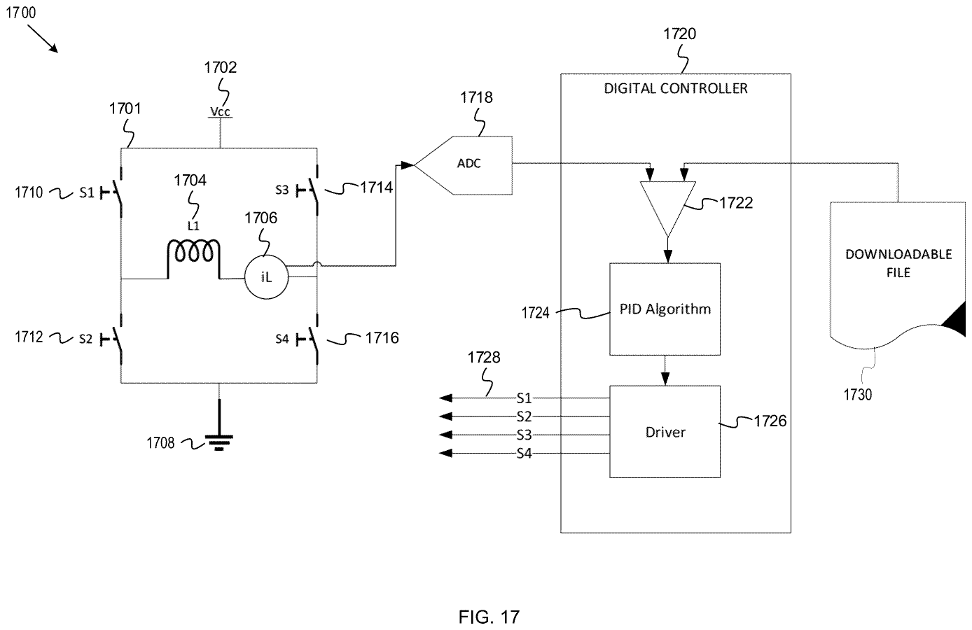

FIG. 17 depicts a free-wheeling pulse width modulator H-bridge circuit with a digital control system usable as a component in a well system, according to some implementations. FIG. 17 depicts a free-wheeling pulse width modulator H-bridge circuit with a digital control system 1700 that utilizes a feedback design comprising a free-wheeling pulse width modulator H-bridge circuit 1701 (“H-bridge 1701”), an analog-to-digital converter 1718, a digital controller 1720, and a downloadable file 1730.

The H-bridge 1701 comprises a power source 1702, an inductor 1704, current sensor 1706, a ground 1708, a first switch 1710, a second switch 1712, a third switch 1714, and a fourth switch 1716. A signal from the current sensor 1706 is sent to the analog-to-digital converter 1718. H-bridge 1701 may be the same as H-bridge 100 or may be implemented differently. The current sensor 1706 can be any device that directly measures the current (e.g., an ammeter, current probe, etc.) or indirectly (e.g., magnetometer measuring the magnetic field generated by the inductor 1704).

The digital controller 1720 comprises a comparator 1722, a proportional integral derivative (PID) algorithm module 1724, and a generator and driver module 1726 (“driver 1726”). The digital controller 1720 receives the output of the analog-to-digital converter 1718 and has a set of outputs 1728 for controlling the first switch 1710, the second switch 1712, the third switch 1714, and the fourth switch 1716. The downloadable file 1730 includes a representation of a reference waveform, which may be provided as input to the digital controller 1720 or may be stored in memory (e.g., ROM, RAM, etc.) located within the digital controller 1720 (not depicted).

In operation, the digital controller 1720 cycles the H-bridge 1701 through the first, second, third, and fourth operational configurations as discussed herein. An analog signal representing the current flowing through the inductor 1704 (“the actual waveform”) is created by the current sensor 1706 and sent to the analog-to-digital converter 1718. The analog-to-digital converter 1718 converts the analog signal into a digital signal, which is then provided as input into the comparator 1722 along with the representation of the desired waveform. The comparator 1722 determines the variance between the actual waveform and the reference waveform and then sends the determined variance to the PID algorithm module 1724.

The PID algorithm module 1724 determines an appropriate duty cycle for the pulse widths that will reduce the variance between the actual waveform and the reference waveform. The duty cycle is then provided as input to the driver module 1726. Based on the input from the PID algorithm module 1724, the driver module 1726 generates one or more signals for controlling the H-bridge 1701 configuration and sends the one or more signals via the set of outputs 1728. Each output in the set of outputs 1728 are communicatively coupled with one of the first switch 1710, the second switch 1712, the third switch 1714, or the fourth switch 1716, thus allowing the digital controller 1720 to change the H-bridge 1701 configuration.

Because the digital controller 1720 dynamically determines the variance between the actual waveform generated by the inductor 1704, the digital controller 1720 can dynamically adjust the pulse widths for the pattern segments p₁ and p₂ to compensate for various operational conditions. For example, different formations may have differing amounts of iron and thus may result in differing amounts of current drain from the H-bridge 1701. The amplitude and frequency of the corresponding waveform will vary from the reference waveform, but the digital controller 1720 can detect this variance and increase the amount of current added to the H-bridge 1701 by increasing the pulse widths (i.e., duty cycle) of the first and third operational configurations.

Although depicted as a block diagram with multiple components, the digital controller 1720 and related components may be implemented as software, firmware, hardware, or any combination thereof. Further, although the analog-to-digital converter 1718 is depicted outside of the digital controller 1720, some implementations may include the analog-to-digital converter 1718 within the digital controller 1720.

### Example Waveforms

Being able to control the waveform shape, repetition frequency, amplitude and offset of the current flowing through an inductor can be very useful in generating custom magnetic fields that will selectively interact with specific rock formations. Because the H-bridge switches can be driven by a digital controller as described herein, complex current shapes can be easily generated at no additional cost, without the need to change the hardware, by only modifying the firmware information. In addition to sine waves, square waves, triangle waves, and the like, the H-bridge circuits herein can produce more complex waveforms depending on the particular modulation pattern applied.

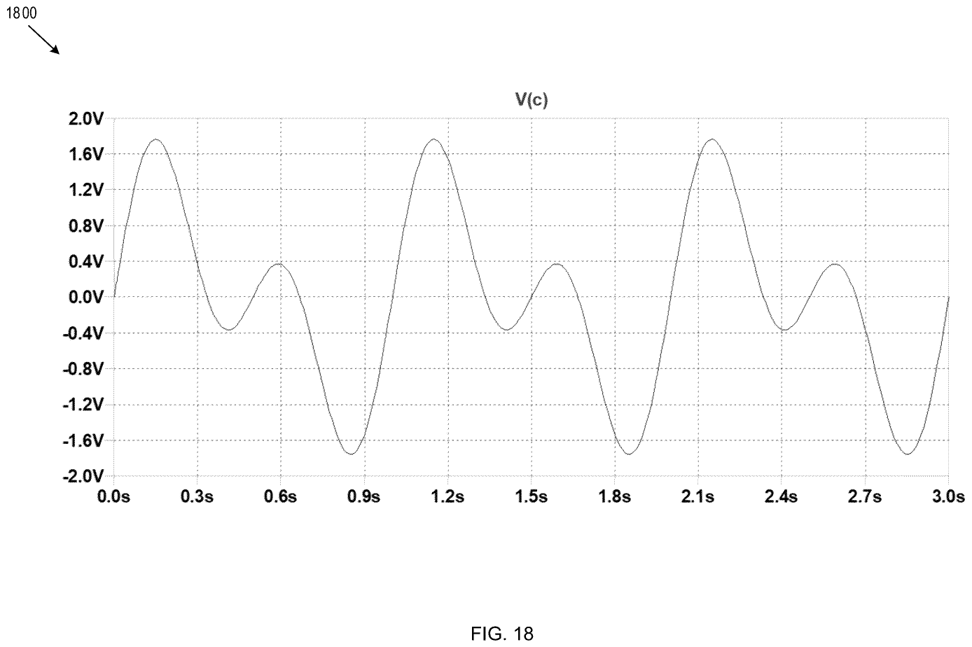

FIG. 18 depicts a first example reference waveform that can be reproduced by a free-wheeling pulse width modulator H-bridge circuit, according to some implementations. FIG. 18 depicts a first example waveform 1800 according to Equation 1, below. A digital controller 1720 or similar component can produce a modulation pattern capable of driving an H-bridge circuit (e.g., H-bridge 100 or H-bridge 900) in such a way that the current passing through the inductor of the H-bridge circuit has a waveform corresponding to the first example waveform 1800. Equation 1, the equation representing the first example waveform is:

$$V ( c ) = sin ( x 1 ) + sin ( x 2 ) , where x 1 = 1 Hz , x 2 = 2 Hz \qquad Equation 1$$

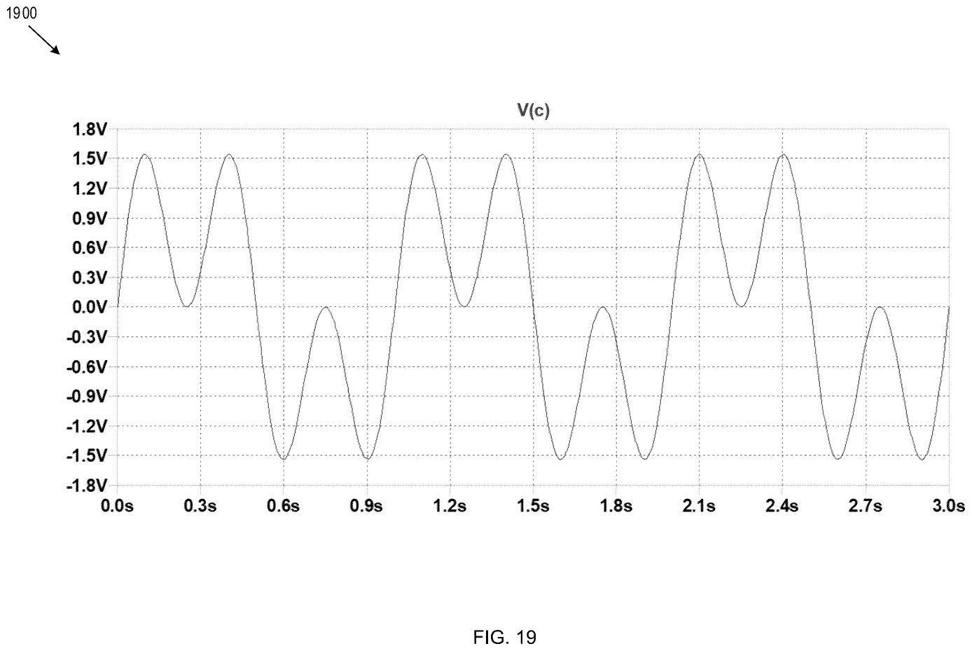

FIG. 19 depicts a second example reference waveform that can be reproduced by a free-wheeling pulse width modulator H-bridge circuit, according to some implementations. FIG. 19 depicts a second example waveform 1900 according to Equation 2, below. A digital controller 1720 or similar component can produce a modulation pattern capable of driving an H-bridge circuit (e.g., H-bridge 100 or H-bridge 900) in such a way that the current passing through the inductor of the H-bridge circuit has a waveform corresponding to the second example waveform 1900. Equation 2, the equation representing the second example waveform is:

$$V ( c ) = sin ( x 1 ) + sin ( x 2 ) , where x 1 = 1 Hz , x 2 = 3 Hz \qquad Equation 2$$

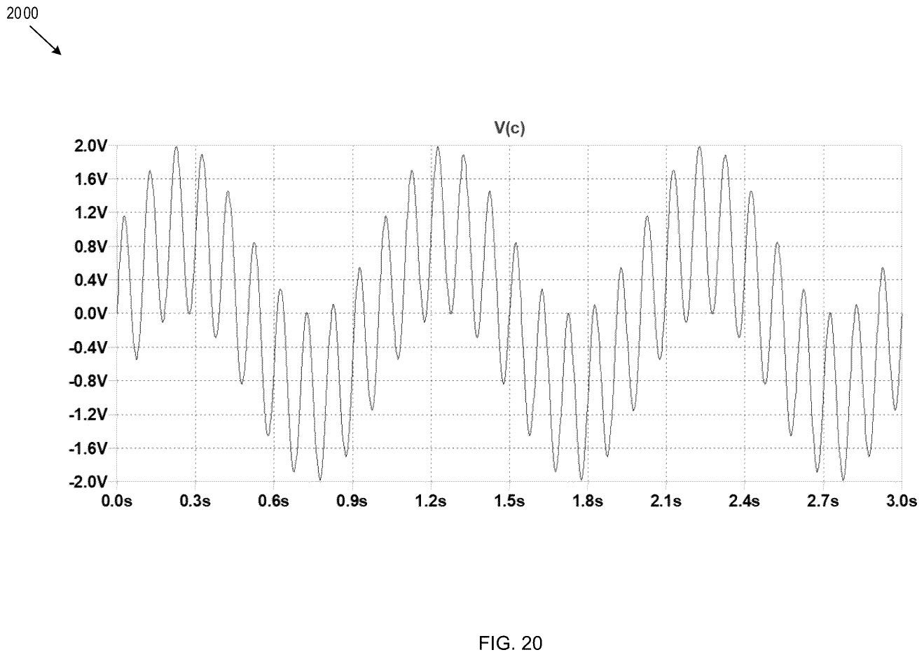

FIG. 20 depicts a third example reference waveform that can be reproduced by a free-wheeling pulse width modulator H-bridge circuit, according to some implementations. FIG. 20 depicts a second example waveform 2000 according to Equation 3, below. A digital controller 1720 or similar component can produce a modulation pattern capable of driving an H-bridge circuit (e.g., H-bridge 100 or H-bridge 900) in such a way that the current passing through the inductor of the H-bridge circuit has a waveform corresponding to the second example waveform 2000. Equation 3, the equation representing the third example waveform is:

$$V ( c ) = sin ( x 1 ) + sin ( x 2 ) , where x 1 = 1 Hz , x 2 = 10 Hz \qquad Equation 3$$

### Example Operations

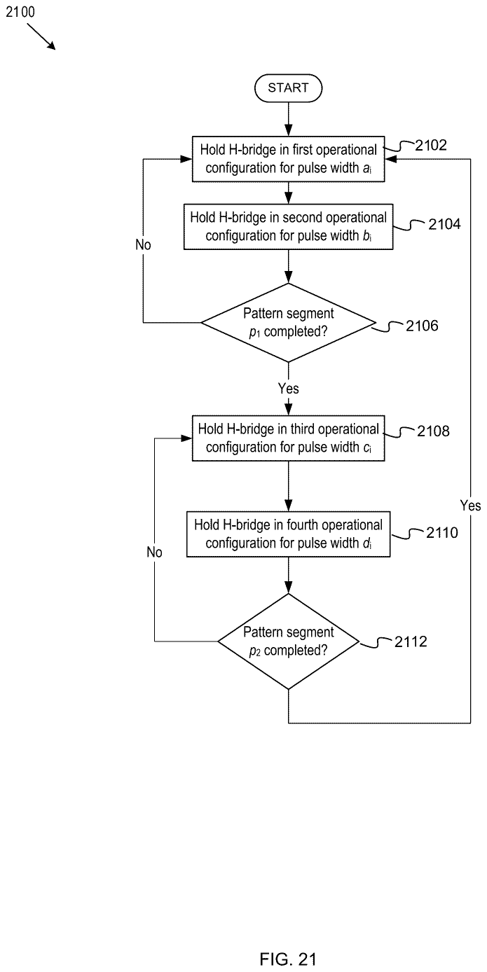

FIG. 21 is a flowchart depicting example operations for controlling a free-wheeling pulse width modulator H-bridge circuit usable as a component in a well system, according to some implementations. FIG. 21 depicts a flowchart 2100, with operations beginning at block 2102. The operations depicted in the flowchart 2100 can be performed by one or more systems (e.g., the digital controller 1720 of FIG. 17) using software, firmware, hardware, or any combination thereof. The operations of the flowchart 2100 may be described in reference to example systems described herein but the operations can be adapted to work with any suitable implementation.

At block 2102, the H-bridge is held in the first operational configuration for a pulse width aᵢ.

At block 2104, the H-bridge is held in the second operational configuration for a pulse width bᵢ.

At block 2106, it is determined whether pattern segment p₁ has been completed (i.e., the H-bridge has cycled between the first operational configuration and the second operational configuration for a particular length of time). If it is determined that pattern segment p₁ has been competed, control flows to block 2108. If it is determined that pattern segment p₁ has not been completed, control flows back to block 2102.

At block 2108, the H-bridge is held in the third operational configuration for a pulse width cᵢ.

At block 2110, the H-bridge is held in the fourth operational configuration for a pulse width dᵢ.

At block 2112, it is determined whether pattern segment p₂ has been completed (i.e., the H-bridge has cycled between the third operational configuration and the fourth operational configuration for a particular length of time). If it is determined that pattern segment p₂ has been competed, control flows to block 2102. If it is determined that pattern segment p₂ has not been completed, control flows back to block 2108.

As described herein, pattern segment p₁ and pattern segment p₂ consist of a series of pulses with variable pulse widths. Thus, each time the operations of blocks 2102 and 2104 are repeated for pattern segment p₁ and the operations of blocks 2108 and 2110 are repeated for pattern segment p₂, a new pulse width may be used (e.g., the index i is incremented). Further, although different pulse widths are described (a, b, c, and d), the actual pulse widths may be the same (or a combination of same and different).

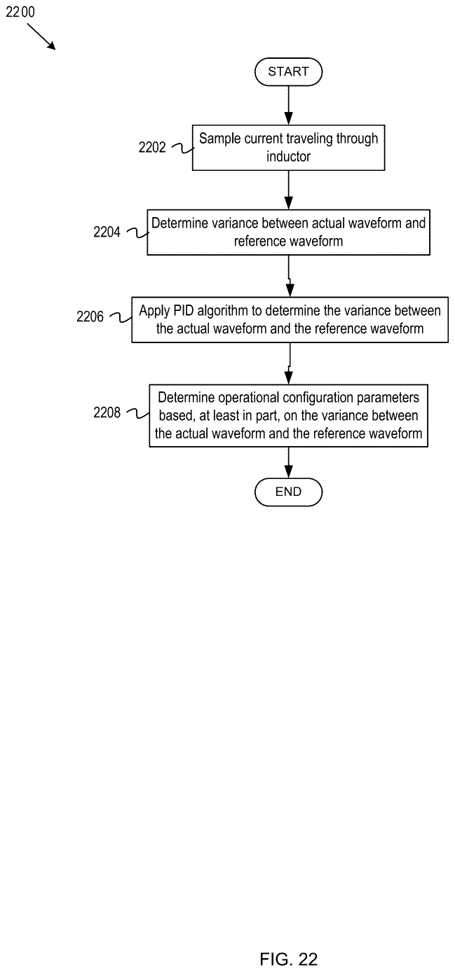

FIG. 22 is a flowchart depicting example operations for adjusting the operational configuration parameters for a free-wheeling pulse width modulator H-bridge circuit usable as a component in a well system, according to some implementations. FIG. 22 depicts a flowchart 2200, with operations beginning at block 2202. The operations depicted in the flowchart 2200 can be performed by one or more systems (e.g., the digital controller 1720 of FIG. 17) using software, firmware, hardware, or any combination thereof. The operations of the flowchart 2200 may be described in reference to system implementations described herein but the operations can be adapted to work with any suitable implementation.

At block 2202, the current traveling through the inductor of an H-bridge is sampled (“actual current”). For example, a sampling analog-to-digital converter (such as analog-to-digital converter 1718 of FIG. 17) may be used to sample the actual current traveling through the inductor (such as the inductor 1704 of FIG. 17). The actual current may be combined with previous samples to construct the actual waveform associated with the current over a particular interval.

At block 2204, the variance between the actual waveform and a reference waveform is determined. The reference waveform may be stored in a form accessible to the component(s) (whether hardware, software, firmware, or a combination thereof) performing the comparison.

At block 2206, a PID algorithm is applied to the variance between the actual waveform and the reference waveform. The specific parameters of the PID algorithm may vary between implementations and uses (e.g., based on the operational characteristics of the well system).

At block 2208, operational parameters are determined based, at least in part, on the variance between the actual waveform and the reference waveform. The operational parameters may be determined by the PID algorithm or may be determined based on the output of the PID algorithm. The operational parameters may include the pulse width, duty cycle, etc.

### Example Well System

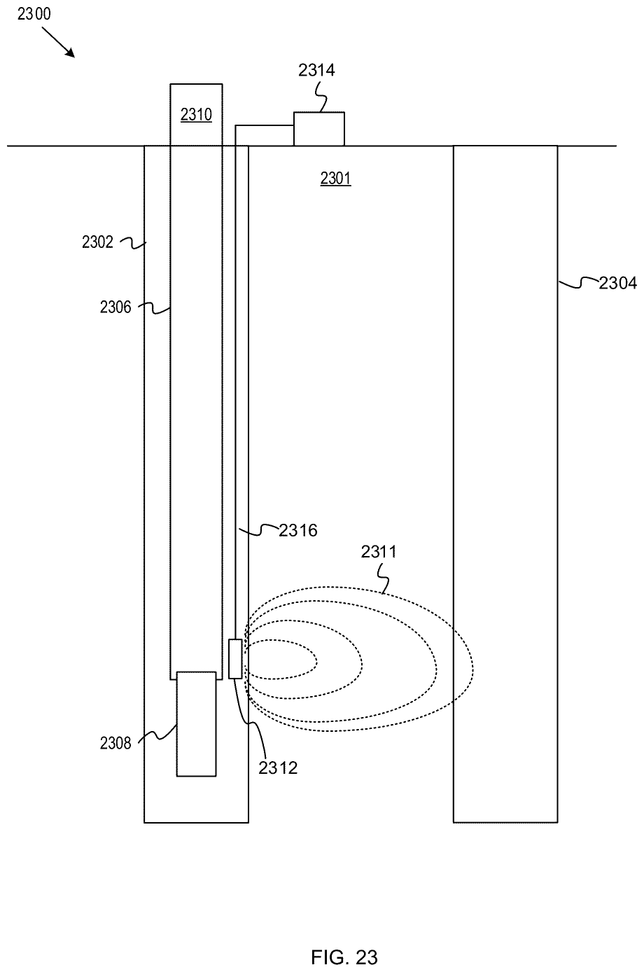

FIG. 23 is a diagrammatic illustration of an example well system, according to some implementations. In particular, FIG. 23 depicts a well system 2300 that comprises a first wellbore 2302 in a formation 2301. The first wellbore 2302 includes a drill string 2306 with a drill bit 2308. The well system 2300 includes a well head 2310. A ranging tool 2312 may be inserted into the first wellbore 2302 and coupled with a power source 2314 via one or more cables 2316.

The ranging tool 2312 can include at least one free-wheeling pulse width modulator H-bridge circuit as described herein. When activated, the free-wheeling pulse width modulator H-bridge circuit generates a magnetic field 2311 which is usable for ranging applications, such as finding a second wellbore 2304.

Although the examples herein describe the use of a free-wheeling pulse width modulator H-bridge in downhole ranging applications, the inventive subject matter is not so limited. For example, a free-wheeling pulse width modulator H-bridge may be used on the surface to determine how deep in a formation a component is; used in a resistivity tool to determine how much resistance a formation has, etc.

### Example Computing Systems

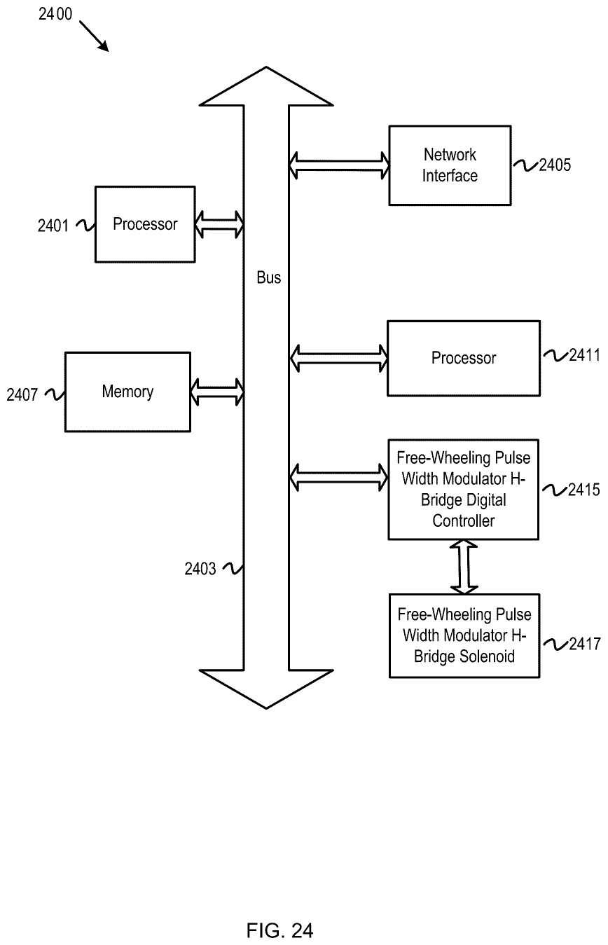

FIG. 24 is a block diagram depicting an example computing system, according to some implementations. FIG. 24 depicts a computing system 2400 for digital control of a free-wheeling pulse width modulator H-bridge solenoid. The computing system 2400 includes a processor 2401 (possibly including multiple processors, multiple cores, multiple nodes, and/or implementing multi-threading, etc.). The computing system 2400 also includes a free-wheeling pulse width modulator H-bridge digital controller 2415 communicatively coupled with a free-wheeling pulse width modulator H-bridge solenoid 2417. The free-wheeling pulse width modulator H-bridge digital controller 2415 may perform the operations described herein. For example, the free-wheeling pulse width modulator H-bridge digital controller 2415 sample the actual current flowing through the free-wheeling pulse width modulator H-bridge solenoid 2417, determine the difference between the actual current and a reference current, apply a PID algorithm to the difference between the actual current and the reference current, and determine operational configuration parameters based, at least in part, on the difference between the actual current and the reference current. Any one of the previously described functionalities may be partially (or entirely) implemented in hardware and/or on the free-wheeling pulse width modulator H-bridge digital controller 2415. For example, the functionality may be implemented with an application specific integrated circuit, in logic implemented in the free-wheeling pulse width modulator H-bridge digital controller 2415, in a co-processor on a peripheral device or card, etc. Further, realizations may include fewer or additional components not illustrated in FIG. 24 (e.g., video cards, audio cards, additional network interfaces, peripheral devices, etc.). The processor 2401 and the network interface 2405 are coupled to the bus 2403. Although illustrated as being coupled to the bus 2403, the memory 2407 may be coupled to the processor 2401. The computing system 2400 includes memory 2407. The memory 2407 may be system memory or any one or more possible realizations of machine-readable media. The computing system 2400 can communicate via transmissions to and/or from remote devices via the network interface 2405 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

### Example Implementations

Implementation 1: A method for operating a solenoid, the method comprising cycling the solenoid between a first operational configuration and a second operational configuration for a first pattern segment, wherein the solenoid comprises an H-bridge circuit, wherein the H-bridge circuit comprises a power source and an inductor; and in response to completing the first pattern segment, cycling the solenoid between a third operational configuration and a fourth operational configuration for a second pattern segment.

Implementation 2: The method according to any of the preceding Implementations, wherein the second operational configuration and the fourth operational configuration comprise free-wheeling operational configurations.

Implementation 3: The method according to any of the preceding Implementations, wherein current flows through the inductor in a first direction when the solenoid is in the first operational configuration and the second operational configuration and wherein current flows in a second direction when the solenoid is in the third operational configuration and the fourth operational configuration.

Implementation 4: The method according to any of the preceding Implementations, the method further comprising sampling a current flowing through the inductor to generate a current sample; combining the current sample with one or more previously collected current samples to generate an actual waveform; determining a variance between the actual waveform and a reference waveform; and modifying, based at least in part on the variance, an operational parameter associated with at least one of the first operational configuration, the second operational configuration, the third operational configuration, or the fourth operational configuration.

Implementation 5: The method according to Implementation 4, wherein said modifying the operational parameter comprises changing a pulse width associated with at least one of the first operational configuration, the second operational configuration, the third operational configuration, or the fourth operational configuration.

Implementation 6: The method according to any of the preceding Implementations, wherein the first operation configuration, the second operational configuration, the third operational configuration, and the fourth operational configuration are associated with a first of a plurality of reference waveforms.

Implementation 7: The method according to any of the preceding Implementations, the method further comprising determining that current through the solenoid should correspond to a second of the plurality of reference waveforms; in response to determining that current through the solenoid should correspond to the second of the plurality of reference waveforms, cycling the solenoid between a fifth operational configuration and a sixth operational configuration for a third pattern segment; and in response to completing the third pattern segment, cycling the solenoid between a seventh operational configuration and an eighth operational configuration for a fourth pattern segment

Implementation 8: The method according to any of the preceding Implementations, wherein the first pattern segment comprises a first series of pulses corresponding to a first 90 degrees of a waveform followed by a second series of pulses corresponding to a second 90 degrees of the waveform, wherein the second pattern segment comprises a third series of pulses corresponding to a third 90 degrees of the waveform followed by a fourth series of pulses corresponding to a fourth 90 degrees of the waveform.

Implementation 9: A system comprising an H-bridge circuit, the H-bridge circuit comprising an inductor and a plurality of switches; a power source that provides current to the H-bridge circuit; and a digital controller communicatively coupled with the H-bridge circuit, the digital controller comprising one or more processors and one or more non-transitory computer-readable mediums including instructions which, when executed by the one or more processors, cause the one or more processors to execute one or more operations for controlling the H-bridge circuit, the instructions including: instructions to cycle the H-bridge circuit between a first operational configuration and a second operational configuration for a first pattern segment; and instructions to cycle, in response to completion of the first pattern segment, the H-bridge circuit between a third operational configuration and a fourth operational configuration for a second pattern segment.

Implementation 10: The system according to any of the preceding Implementations, wherein the instructions to cycle the H-bridge circuit between the first operational configuration and the second operational configuration comprises instructions to configure the plurality of switches to allow current to flow from the power source through the inductor; and configure the plurality of switches to prevent current from flowing from the power source through the inductor.

Implementation 11: The system according to any of the preceding Implementations, wherein the instructions further comprise instructions to sample a current flowing through the inductor to generate a current sample; combine the current sample with one or more previously collected current samples to generate an actual waveform; determine a variance between the actual waveform and a reference waveform; and modify, based at least in part on the variance, an operational parameter associated with at least one of the first operational configuration, the second operational configuration, the third operational configuration, or the fourth operational configuration.

Implementation 12: The system according to Implementation 11, wherein the instructions to modify the operational parameter comprise instructions to change a pulse width associated with at least one of the first operational configuration, the second operational configuration, the third operational configuration, or the fourth operational configuration.

Implementation 13: The system according to any of the preceding Implementations, wherein the first pattern segment comprises a first series of pulses followed by a second series of pulses, wherein the second pattern segment comprises a third series of pulses followed by a fourth series of pulses.

Implementation 14: The system according to Implementation 13, wherein the first series of pulses corresponds to a first 90 degrees of a waveform, the second series of pulses corresponds to a second 90 degrees of the waveform, the third series of pulses corresponds to a third 90 degrees of the waveform, and the fourth series of pulses corresponds to a fourth 90 degrees of the waveform.

Implementation 15: One or more non-transitory computer-readable mediums including instructions which, when executed by a processor, cause the processor to execute one or more operations for controlling an H-bridge circuit, the instructions comprising instructions to cycle the H-bridge circuit between a first operational configuration and a second operational configuration for a first pattern segment; and instructions to cycle, in response to completion of the first pattern segment, the H-bridge circuit between a third operational configuration and a fourth operational configuration for a second pattern segment.

Implementation 16: The one or more non-transitory computer-readable mediums according to any of the preceding Implementations, the instructions further including instructions to sample current flowing through an inductor of the H-bridge circuit to generate a first current sample; combine the first current sample with a first set of previously collected current samples to generate a first actual waveform; determine a first variance between the first actual waveform and a first reference waveform of a plurality of reference waveforms; and modify, based at least in part on the first variance, an operational parameter associated with at least one of the first operational configuration, the second operational configuration, the third operational configuration, or the fourth operational configuration.

Implementation 17: The one or more non-transitory computer-readable mediums according to Implementation 16, the instructions further including instructions to sample current flowing through the inductor of the H-bridge circuit to generate a second current sample; combine the second current sample with a second set of previously collected current samples to generate a second actual waveform; determine a second variance between the second actual waveform and a second reference waveform of the plurality of reference waveforms; and modify, based at least in part on the second variance, the operational parameter.

Implementation 18: The one or more non-transitory computer-readable mediums according to Implementation 16, wherein the instructions to modify the operational parameter comprise instructions to change a pulse width associated with at least one of the first operational configuration, the second operational configuration, the third operational configuration, or the fourth operational configuration.

Implementation 19: The one or more non-transitory computer-readable mediums according to any of the preceding Implementations wherein the first pattern segment comprises a first series of pulses followed by a second series of pulses, wherein the second pattern segment comprises a third series of pulses followed by a fourth series of pulses.

Implementation 20: The one or more non-transitory computer-readable mediums according to Implementation 19, wherein the first series of pulses corresponds to a first 90 degrees of a waveform, the second series of pulses corresponds to a second 90 degrees of the third series of pulses corresponds to a third 90 degrees of the waveform, and the fourth series of pulses corresponds to a fourth 90 degrees of the waveform.

1. A method for operating a solenoid, the method comprising:
cycling the solenoid between a first operational configuration and a second operational configuration for a first pattern segment, wherein the solenoid comprises an H-bridge circuit, wherein the H-bridge circuit comprises a power source and an inductor; and
in response to completing the first pattern segment, cycling the solenoid between a third operational configuration and a fourth operational configuration for a second pattern segment.

2. The method of claim 1, wherein the second operational configuration and the fourth operational configuration comprise free-wheeling operational configurations.

3. The method of claim 2, wherein current flows through the inductor in a first direction when the solenoid is in the first operational configuration and the second operational configuration and wherein current flows in a second direction when the solenoid is in the third operational configuration and the fourth operational configuration.

4. The method of claim 1, further comprising:
sampling a current flowing through the inductor to generate a current sample;
combining the current sample with one or more previously collected current samples to generate an actual waveform;
determining a variance between the actual waveform and a reference waveform; and
modifying, based at least in part on the variance, an operational parameter associated with at least one of the first operational configuration, the second operational configuration, the third operational configuration, or the fourth operational configuration.

5. The method of claim 4, wherein said modifying the operational parameter comprises changing a pulse width associated with at least one of the first operational configuration, the second operational configuration, the third operational configuration, or the fourth operational configuration.

6. The method of claim 1, wherein the first operation configuration, the second operational configuration, the third operational configuration, and the fourth operational configuration are associated with a first of a plurality of reference waveforms.

7. The method of claim 6, further comprising:
determining that current through the solenoid should correspond to a second of the plurality of reference waveforms;
in response to determining that current through the solenoid should correspond to the second of the plurality of reference waveforms, cycling the solenoid between a fifth operational configuration and a sixth operational configuration for a third pattern segment; and
in response to completing the third pattern segment, cycling the solenoid between a seventh operational configuration and an eighth operational configuration for a fourth pattern segment.

8. The method of claim 1, wherein the first pattern segment comprises a first series of pulses corresponding to a first 90 degrees of a waveform followed by a second series of pulses corresponding to a second 90 degrees of the waveform, wherein the second pattern segment comprises a third series of pulses corresponding to a third 90 degrees of the waveform followed by a fourth series of pulses corresponding to a fourth 90 degrees of the waveform.

9. A system comprising:
an H-bridge circuit comprising an inductor and a plurality of switches;
a power source that provides current to the H-bridge circuit; and
a digital controller communicatively coupled with the H-bridge circuit, the digital controller comprising one or more processors and one or more non-transitory computer-readable mediums including instructions which, when executed by the one or more processors, cause the one or more processors to execute one or more operations for controlling the H-bridge circuit, the instructions including:
instructions to cycle the H-bridge circuit between a first operational configuration and a second operational configuration for a first pattern segment; and
instructions to cycle, in response to completion of the first pattern segment, the H-bridge circuit between a third operational configuration and a fourth operational configuration for a second pattern segment.

10. The system of claim 9, wherein the instructions to cycle the H-bridge circuit between the first operational configuration and the second operational configuration comprises instructions to:
configure the plurality of switches to allow current to flow from the power source through the inductor; and
configure the plurality of switches to prevent current from flowing from the power source through the inductor.

11. The system of claim 9, wherein the instructions further comprise instructions to:
sample a current flowing through the inductor to generate a current sample;
combine the current sample with one or more previously collected current samples to generate an actual waveform;
determine a variance between the actual waveform and a reference waveform; and
modify, based at least in part on the variance, an operational parameter associated with at least one of the first operational configuration, the second operational configuration, the third operational configuration, or the fourth operational configuration.

12. The system of claim 11, wherein the instructions to modify the operational parameter comprise instructions to change a pulse width associated with at least one of the first operational configuration, the second operational configuration, the third operational configuration, or the fourth operational configuration.

13. The system of claim 9, wherein the first pattern segment comprises a first series of pulses followed by a second series of pulses, wherein the second pattern segment comprises a third series of pulses followed by a fourth series of pulses.

14. The system of claim 13, wherein the first series of pulses corresponds to a first 90 degrees of a waveform, the second series of pulses corresponds to a second 90 degrees of the waveform, the third series of pulses corresponds to a third 90 degrees of the waveform, and the fourth series of pulses corresponds to a fourth 90 degrees of the waveform.

15. One or more non-transitory computer-readable mediums including instructions which, when executed by a processor, cause the processor to execute one or more operations for controlling an H-bridge circuit, the instructions comprising:
instructions to cycle the H-bridge circuit between a first operational configuration and a second operational configuration for a first pattern segment; and
instructions to cycle, in response to completion of the first pattern segment, the H-bridge circuit between a third operational configuration and a fourth operational configuration for a second pattern segment.

16. The one or more non-transitory computer-readable mediums of claim 15, the instructions further including instructions to:
sample current flowing through an inductor of the H-bridge circuit to generate a first current sample;
combine the first current sample with a first set of previously collected current samples to generate a first actual waveform;
determine a first variance between the first actual waveform and a first reference waveform of a plurality of reference waveforms; and
modify, based at least in part on the first variance, an operational parameter associated with at least one of the first operational configuration, the second operational configuration, the third operational configuration, or the fourth operational configuration.

17. The one or more non-transitory computer-readable mediums of claim 16, the instructions further including instructions to:
sample current flowing through the inductor of the H-bridge circuit to generate a second current sample;
combine the second current sample with a second set of previously collected current samples to generate a second actual waveform;
determine a second variance between the second actual waveform and a second reference waveform of the plurality of reference waveforms; and
modify, based at least in part on the second variance, the operational parameter.

18. The one or more non-transitory computer-readable mediums of claim 16, wherein the instructions to modify the operational parameter comprise instructions to change a pulse width associated with at least one of the first operational configuration, the second operational configuration, the third operational configuration, or the fourth operational configuration.

19. The one or more non-transitory computer-readable mediums of claim 15, wherein the first pattern segment comprises a first series of pulses followed by a second series of pulses, wherein the second pattern segment comprises a third series of pulses followed by a fourth series of pulses.

20. The one or more non-transitory computer-readable mediums of claim 19, wherein the first series of pulses corresponds to a first 90 degrees of a waveform, the second series of pulses corresponds to a second 90 degrees of the third series of pulses corresponds to a third 90 degrees of the waveform, and the fourth series of pulses corresponds to a fourth 90 degrees of the waveform.
